(19) United States
(12) Patent Application Publication
(10) Pub. No.: US 2011/0186088 A1
(43) Pub. Date: Aug. 4, 2011

(54) SUBSTRATE NEST WITH DRIP REMOVER

(76) Inventors: Kenneth C. Miller, Fremont, CA (US); Rito Ligutom, Fremont, CA (US); Helmuth Treichel, Fremont, CA (US); Flint Thorne, Fremont, CA (US)

(21) Appl. No.: 12/697,260

(22) Filed: Jan. 31, 2010

(51) Int. Cl. B08B 3/00

(52) U.S. Cl. 134/32; 134/61

(57) ABSTRACT

An apparatus for supporting a work piece is provided. The apparatus includes outer support rails having support slots for supporting the work piece, the outer support rails disposed on opposing sides of the apparatus between opposing end members of the apparatus. Inner support rails extend between the opposing end members of the apparatus. An inner surface of each of the inner support rails has vertically disposed extensions extending therefrom. The vertically disposed extensions are aligned in pairs along a length of the inner support rails. A moveable device is disposed between the pairs of vertically disposed extensions. The moveable device is buoyantly moveable so that as the work piece is lifted, the moveable device follows. A method for cleaning a work piece is also included.

### BACKGROUND

In many manufacturing processes for semiconductor and/or magnetic disk manufacturing, it is necessary to treat a work piece in a liquid environment and then dry the work piece. As is well known, particulates or contaminates that attach during the drying process may eventually cause defects in the work piece. In addition, inefficient drying may not only add to the processing time, but may also leave defects on a surface of the work piece, as well as promote oxidation. Thus, it is extremely important that when a substrate is dried, there are no impurities left on its surface. In addition, during the drying process, a work piece holding mechanism is in contact with the work piece. One of the defects sometimes left during the drying process is a drying mark at a point of contact where a work piece is held during drying. In order to eliminate this defect, the embodiments described below provide a mechanism for efficiently drying a semiconductor and/or magnetic disk work piece.

It is within this context that embodiments of the invention arise.

### SUMMARY OF THE INVENTION

Broadly speaking, embodiments of the present invention fill these needs by providing methods of and apparatus configured to efficiently clean work pieces, especially substrates for the semiconductor and/or magnetic disk manufacturing process.

In one embodiment, an apparatus for supporting a work piece is provided. The apparatus includes outer support rails having support slots for supporting the work piece, the outer support rails disposed on opposing sides of the apparatus between opposing end members of the apparatus. Inner support rails extend between the opposing end members of the apparatus. An inner surface of each of the inner support rails has vertically disposed extensions extending therefrom. The vertically disposed extensions are aligned in pairs along a length of the inner support rails. A moveable device is disposed between the pairs of vertically disposed extensions. The moveable device is buoyantly moveable so that as the work piece is lifted out of a liquid during drying, the moveable device follows.

In another embodiment, a support nest for cleaning a work piece is provided. The support nest includes a plurality of spaced apart wicking devices moveably disposed between pairs of vertically disposed extensions extending from inner surfaces of support rails. The support rails are disposed along a length of the support nest. The wicking devices are moveable along vertical guides defined along the inner surfaces of the support rails so that as the work piece is lifted from a cleaning liquid, the wicking devices travel with corresponding work pieces to maintain contact with an edge of the work piece. In addition, when the support nest is submerged in the cleaning liquid, a top portion of the wicking devices extends above the surface of the cleaning liquid when the wicking device is fully extended.

In yet another embodiment, a method for cleaning a work piece is provided. The method includes raising a work piece submerged in a cleaning bath toward a bath fluid/air interface and lifting the work piece from a submerged support with a transition arm located above the fluid/air interface. The method further includes following a bottom edge of the work piece with a wicking device moveably attached to the submerged support, wherein the wicking device contacts the bottom edge of the work piece. Movement of the wicking device is halted after a top portion breaks the bath fluid/air interface while the submerged support remains submerged. The bottom edge of the work piece remains in contact with the wicking device as it passes through the fluid/air interface.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a simplified schematic diagram illustrating an overview of a substrate cleaning system utilizing the support nest having individual wicking devices in accordance with one embodiment of the invention.

FIG. 2 is a simplified schematic diagram illustrating a support nest that includes individualized wicking devices for each work piece in accordance with one embodiment of the invention.

FIG. 3 is a simplified schematic diagram illustrating a top view of a support nest having a movable wicking device in accordance with one embodiment of the invention.

FIG. 4 is a simplified schematic diagram illustrating a cross-sectional view along a length of the support nest and individual wicking devices in accordance with one embodiment of the invention.

FIG. 5 is a simplified schematic diagram illustrating a cross-sectional view along a width of the support nest in accordance with one embodiment of the invention.

FIG. 6 is a simplified schematic diagram of the wicking device in accordance with one embodiment of the invention.

FIG. 7 is a simplified schematic diagram illustrating a side view of the wicking device in accordance with one embodiment of the invention.

FIG. 8 is a simplified schematic diagram illustrating a cross-sectional view of the wicking device in accordance with one embodiment of the invention.

FIG. 9 is a simplified schematic diagram illustrating a cross-sectional view of the support nest and wicking device in accordance with one embodiment of the invention.

FIG. 10 is a simplified schematic diagram illustrating an alternative embodiment for the wicking device in accordance with one embodiment of the invention.

FIG. 11 is a flowchart illustrating the method operations for cleaning a work piece in accordance with one embodiment of the invention.

### DETAILED DESCRIPTION

The embodiments described below relate to apparatus for supporting a work piece during cleaning and drying operations. In one embodiment, the apparatus may be used to support magnetic disks that store data. It should be appreciated that the embodiments are not limited to supporting magnetic disks, in that any semiconductor circuit device, flat panel display, or other substrate may be supported for cleaning by the embodiments described herein. The term work piece as used herein may refer to any substrate being processed. In addition, the terms disk and disc are used interchangeably, and may also reference any such substrate or work piece. . For example, the support can be utilized for a cleaning operation with a dual hand off mechanism as described in U.S. patent application Ser. No. 11/531,905, and a drying chamber as described in U.S. patent application Ser. No. 12/122,571, both of which are incorporated herein by reference for all purposes.

The embodiments described herein provide for a support nest that supports a plurality of work pieces during a cleaning and drying operation. The support nest includes individual wicking devices for each work piece in order to prevent any fluids stains or marks on the surface of the disk. The individual wicking devices for each work piece mitigate or reduce the occurrence of watermarks and stains by following or traveling with the work piece as the work piece is raised from the support nest to a location above a fluid air interface. As will be described in more detail below, the embodiments utilizes a movable device that can be buoyant to stay in contact with each work piece at a lowermost location, e.g., a six o'clock location on the work piece as the work piece is lifted, until the work pieces are completely out of the fluid bath. The buoyancy of the movable device is such that the work piece will not be lifted out of the support nest by the movable device.

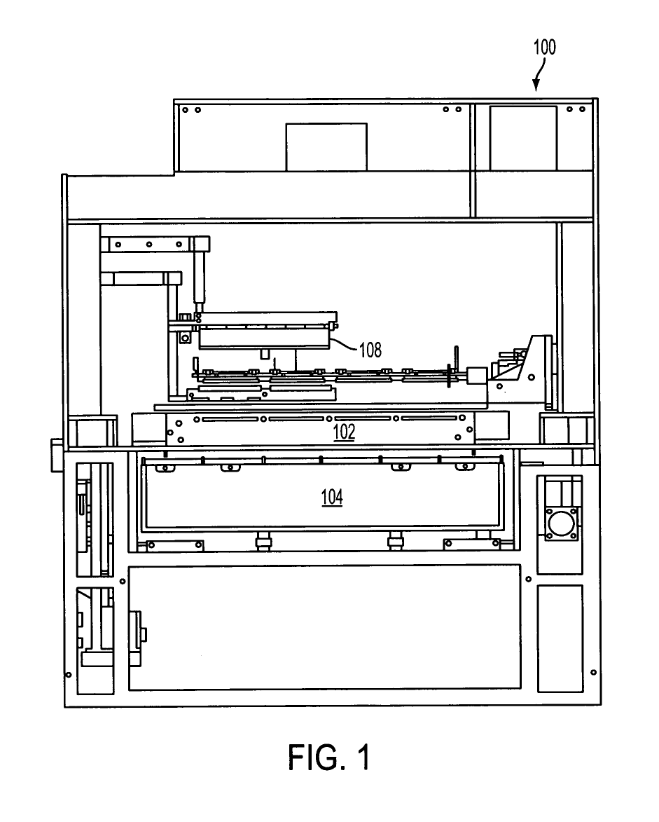

FIG. 1 is a simplified schematic diagram illustrating an overview of a substrate cleaning system 100 utilizing the support nest having individual wicking devices in accordance with one embodiment of the invention. Substrate cleaning system 100 can include a drying chamber 102, a cleaning tank 104, and a transport assembly 108. After controlled exposure within the cleaning tank 104, e.g., a fluid bath, substrates or work pieces are moved via transport assembly 108 to drying chamber 102. Drying chamber 102 may be a chamber or just an open area above the fluid bath. Support nests that include individual wicking devices that are described in more detail below, may be integrated into transport assembly 108 in one embodiment. For further information regarding the transport assembly 108, refer to U.S. patent application Ser. No. 11/531,905. It should be appreciated that the system of FIG. 1 is one exemplary system that may be used for the support nest and wicking device described herein and is not meant to be limiting as the wicking device may be used in other suitable systems. In addition, the system components of FIG. 1 are illustrative and not drawn to scale.

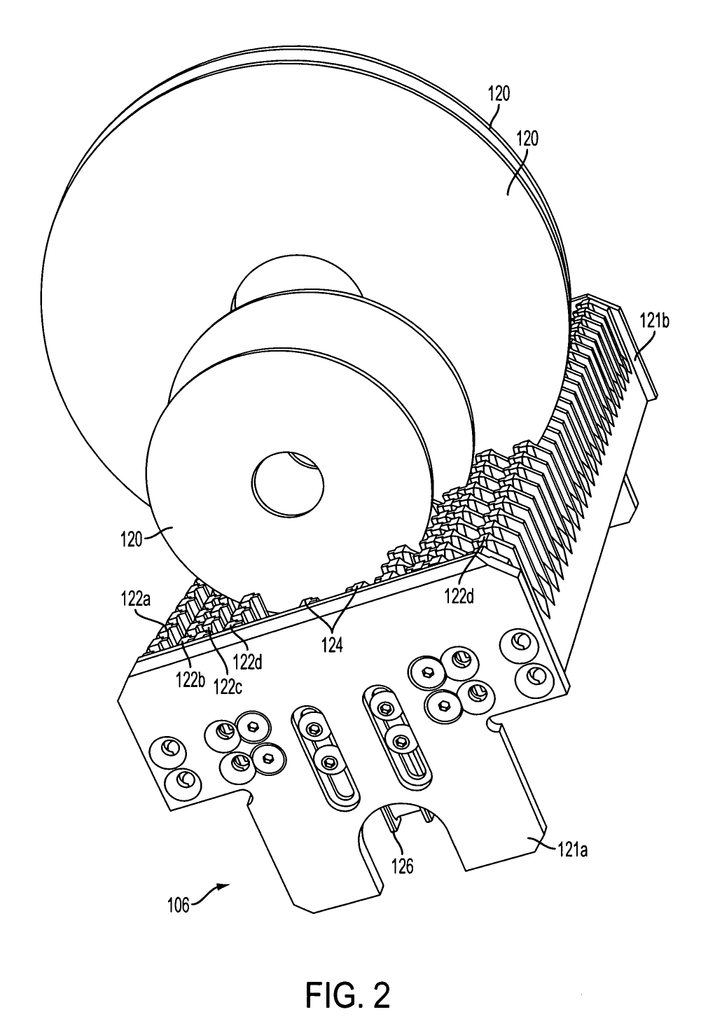

FIG. 2 is a simplified schematic diagram illustrating a support nest that includes individualized wicking devices for each work piece in accordance with one embodiment of the invention. Support nest 106 includes two end members 121a and 121b between which are disposed a plurality of outer support rails 122a through 122d. Outer support rails 122a through 122d are configured to support a variety of different diameters of work pieces 120 in one embodiment. In the embodiments shown herein work pieces 120 are illustrated as magnetic disks, however, any suitable work piece, such as semiconductor substrates, glass substrates, etc., may be held within support nest 106. Each of outer support rails 122a through 122d are configured with saw tooth openings that provide support for corresponding work piece 120. As illustrated in FIG. 2, outer support rails 122a through 122d are disposed in corresponding pairs. That is, each outer support rail has a corresponding outer support rail disposed along and opposing side of support nest 106 where the corresponding pairs are equidistant from a centerline of the support nest in one embodiment. Multiple outer support rail pairs are shown supporting multiple disc sizes. However, in practice, only two outer support rails are used at a time for one size disc. Support nest 106 further includes inner support rails 124 which extend between opposing end members 121a and 121b of the support nest. Wicking device 126 is moveably disposed between vertical extensions extending from the inner surfaces of opposing inner support rails 124. Wicking device 126 is described in more detail below.

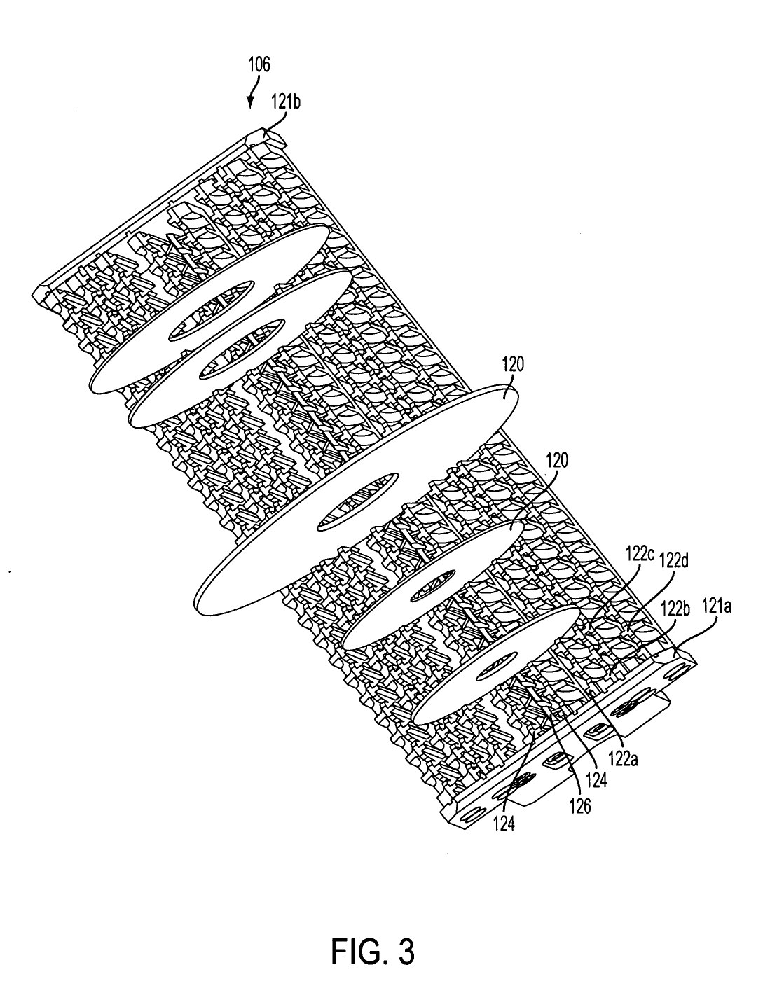

FIG. 3 is a simplified schematic diagram illustrating a top view of a support nest having a movable wicking device in accordance with one embodiment of the invention. Support nest 106 supports a plurality of work pieces 120. Depending on a diameter of work piece 120, saw-tooth slots defined within outer support rails 122a through 122c provide the required support for holding each of the work pieces in a substantially vertical orientation. Inner support rails 124 extend between end members 121a and 121b of support nest 106 and are defined between outer carriers 122a through 122c. In one embodiment, extensions defined on opposing surfaces of corresponding inner support rails guide wicking device 126 in a vertical manner so that a surface of a top portion of wicking device 126 remains in contact with a bottom edge of work piece 120 as the work piece is moved from support nest 106. One skilled in the art will appreciate that the support nest may be submerged in a fluid bath for a cleaning operation in one embodiment. The fluid bath may be any suitable cleaning chemistry for cleaning semiconductor substrates and magnetic disks including deionized water. Upon completion of the cleaning operation the support nest is raised towards an air fluid interface above the fluid bath. The work pieces are moved above the air fluid interface while support nest 106 remains submerged in the fluid bath. A transport mechanism removes work pieces 120 from support nest 106 and as the work pieces are lifted, wicking device 126 remains in contact with the bottom edge of the work piece. In one embodiment, wicking device 126 is buoyant, i.e., floats in the fluid of the fluid bath.

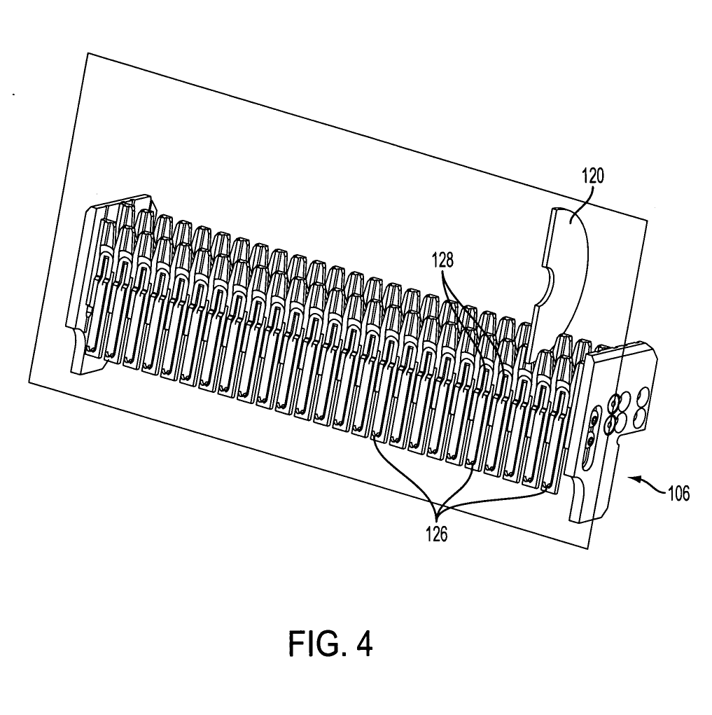

FIG. 4 is a simplified schematic diagram illustrating a cross-sectional view along a length of the support nest and individual wicking devices in accordance with one embodiment of the invention. Wicking devices 126 are disposed along a length of support nest 106. In this exemplary embodiment wicking devices 126 are hollow, in order to be buoyant. In one embodiment a top edge 128 of wicking device 126 remains in contact with the bottom surface of work piece 120. It should be appreciated that in the embodiments described herein wicking device 126 is buoyant, but is not capable of lifting work piece 120. That is, wicking device 126 follows movement of the work piece and does not initiate movement of the work piece, as the movement of the work piece is provided by an external mechanism. It should be appreciated that the support nests illustrated herein are exemplary in dimensions and the number of work pieces capable of being supported. Accordingly, these exemplary illustrations are not meant to be limiting.

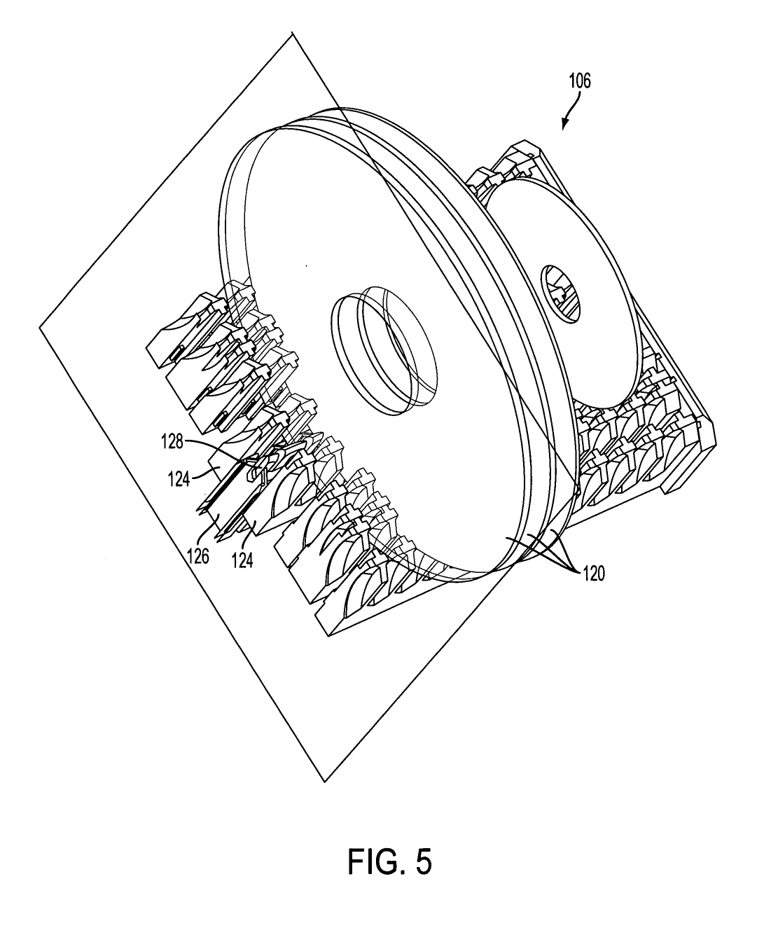

FIG. 5 is a simplified schematic diagram illustrating a cross-sectional view along a width of the support nest in accordance with one embodiment of the invention. Support nest 106 is illustrating supporting a plurality of work pieces 120. Each work piece has a corresponding individual wicking device 126 that is in contact with a bottom edge of the vertically oriented work pieces. In one embodiment the point of contact with the bottom edge is approximately at the six o′clock position. Wicking device 126 is movably disposed between inner support rails 124. As work piece 120 is moved a top surface 128 of wicking device 126 remains in contact with the bottom of the work piece. A distance of travel of wicking device 126 is controlled between the vertically oriented extensions on the inner surface of the inner support rails 124 by providing stops. The stops may be defined on the vertically oriented extensions on the sides of wicking device 126, or a combination of the two, as will be explained further below.

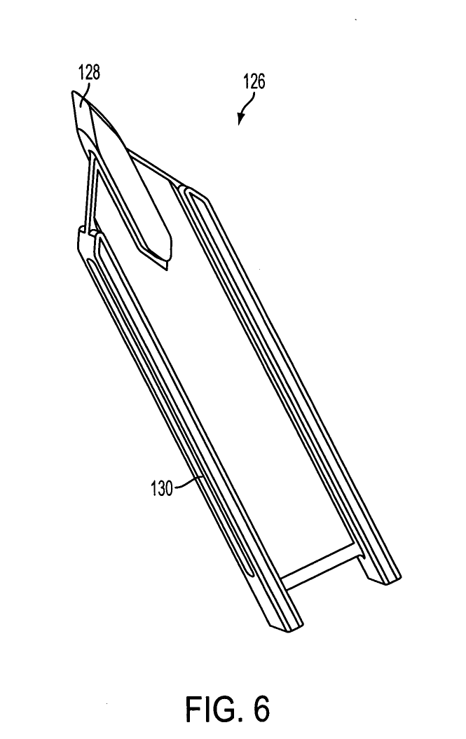

FIG. 6 is a simplified schematic diagram of the wicking device in accordance with one embodiment of the invention. The wicking device 126 has a top edge 128 that contacts the bottom edge of a corresponding work piece. Side surfaces of wicking device 126 have indentation 130 defined along the length of each side surface. Indentation 130 will mate with the corresponding vertical extensions between opposing inner support rail surfaces in order to orient and guide the vertical movement of wicking device 126. In this embodiment the travel is limited by the length of indentation 130. It should be appreciated that the shape of wicking device 126 is not limited to the illustration of FIG. 6. That is, alternative shapes and designs may be used to achieve the functionality of wicking device 126. In addition, alternate configurations can be made for top surface 128 for contacting the bottom edge of a work piece. For example, top surface 128 may have a knife edge, a flat edge that has a width, a curved edge with or without indentations, or any other suitable configuration that will allow contact between the surface and the bottom edge of the work piece.

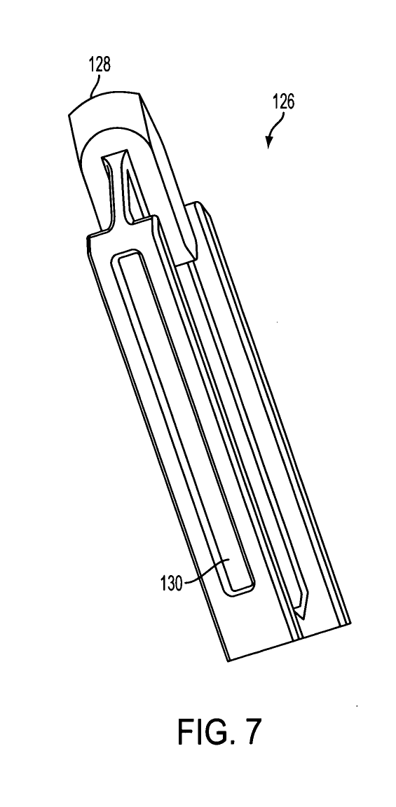

FIG. 7 is a simplified schematic diagram illustrating a side view of the wicking device in accordance with one embodiment of the invention. Wicking device 126 is illustrated having indentation 130 defined along each side surface. As mentioned above, indentation 130 mates with a vertical extension protruding from an inner surface of the inner support rails of the support nest. As the work piece is moved, wicking device 126 travels vertically as guided through the mating of the side extensions and indentation 130, so that top surface 128 remains in contact with a bottom edge of the work piece. As discussed above, wicking device 126 is not capable of lifting the workpiece but can travel along with the workpiece.

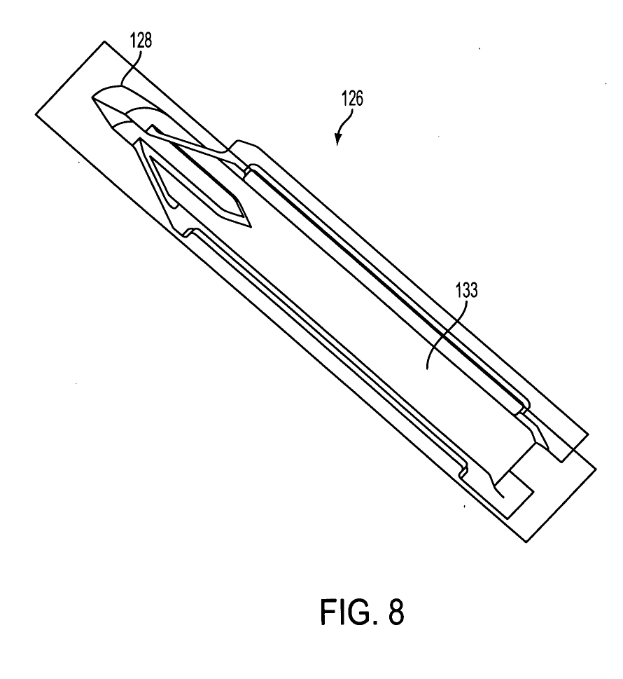

FIG. 8 is a simplified schematic diagram illustrating a cross-sectional view of the wicking device in accordance with one embodiment of the invention. Wicking device 126 is illustrated having a hollow interior 133. The hollow interior 133 enables wicking device 126 to be buoyant. In one embodiment wicking device 126 may be a solid piece and the movement of the wicking device can be controlled through a spring-loaded mechanism. In this embodiment, the force applied by the spring loaded mechanism is not sufficient to lift the work piece, however, the mechanism ensures movement of wicking device 126 with the workpiece. The spring or springs may be located at a base of the wicking device in one embodiment. The material of construction for the springs may be any material compatible with the cleaning fluid and that provides the required spring action over an extended period of use. The wicking device may be composed of any material compatible with the cleaning fluid also. In the buoyant embodiment, wicking device 126 may be composed of a material such, as any suitable metal or plastic material compatible with the process. As mentioned above, top surface 128 remains in contact with a bottom edge of the work piece to enable removal of any remaining fluid on the planar surfaces of the work piece.

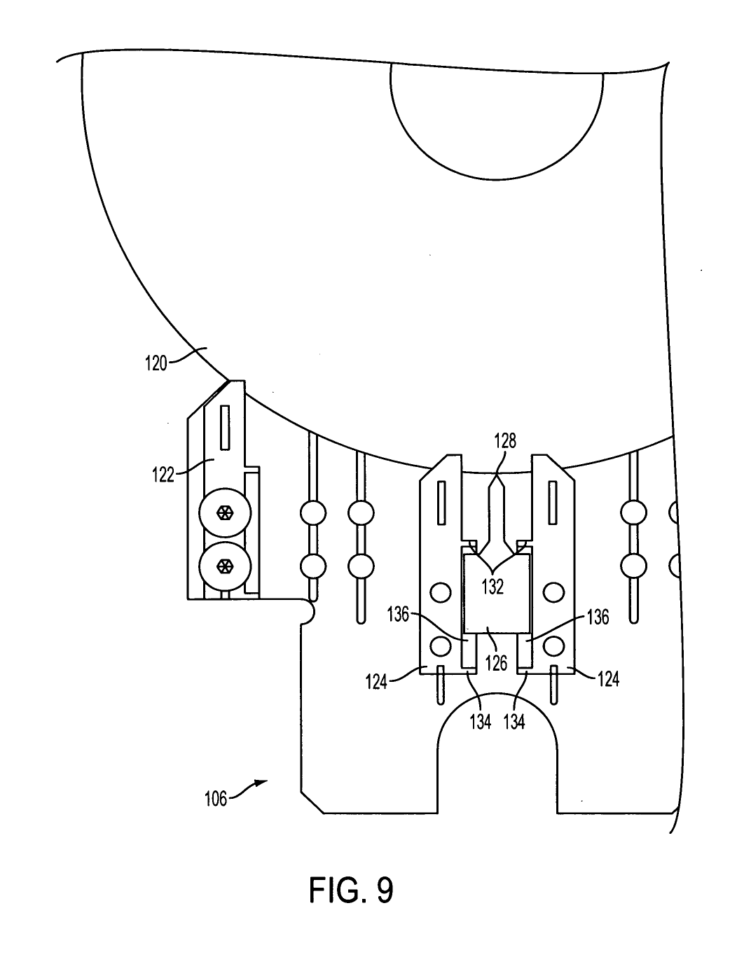

FIG. 9 is a simplified schematic diagram illustrating a cross-sectional view of the support nest and wicking device in accordance with one embodiment of the invention. Work piece 120 is supported by corresponding outer rails of support nest 106. As mentioned above, work piece 120 may be supported through a saw tooth slot defined within the outer rails 122. Inner rails 124 provide vertical extensions 136 which guide wicking device 126 as work piece 120 is moved. The vertical movement of work piece 120 and the buoyancy or spring-loaded mechanism for wicking device 126 provides for contact being maintained between the bottom edge of work piece 120 and the top surface 128 of the wicking device. Travel of wicking device 126 is limited by shoulders 132 and 134 defined on vertical extensions 136. It should be appreciated that the illustrative embodiment in FIG. 9 is not drawn to scale. Thus, through the embodiments described herein wicking device 126 is able to rise above a fluid air interface as work piece 120 is removed from support nest 106. As a result, wicking device 126 causes any fluid remaining proximate to the six o′clock position on work piece 120 to be attracted to the wicking device. Thus, once the vertical movement of wicking device 126 is stopped and the work piece moves away from top surface 128, any fluid remains with the top surface 128 of wicking device 126 through forces of attraction so that the vertically oriented planar surfaces of work piece 120 may be fully dried without any drying marks remaining. Thus, in one embodiment, the wicking device provides a continuous path for the fluid to be pulled off of the work piece by the surface tension of the fluid. The support nest described herein may be composed of any material compatible with the cleaning fluid. Some exemplary material for the support nest includes Polyether ether ketones, and other suitable plastic or metal components that are suitable with the process.

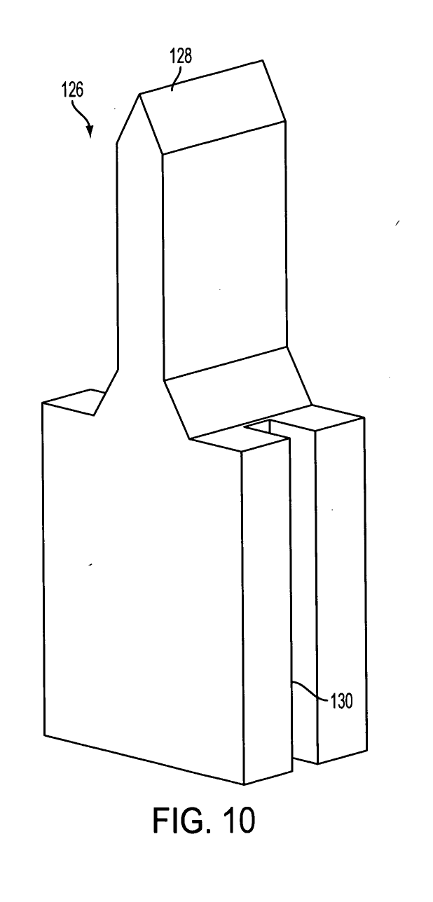

FIG. 10 is a simplified schematic diagram illustrating an alternative embodiment for the wicking device in accordance with one embodiment of the invention. Wicking device 126 includes slots 130 defined along an entire side surface of the wicking device. In this embodiment stops are provided on the inner rails upon which wicking device 126 is guided. Wicking device 126 includes top edge 128, which makes contact with a bottom surface or edge of the work piece. As mentioned above, wicking device 126 may be hollow in order to provide the necessary buoyancy. Alternatively, wicking device 126 may be spring-loaded so that as a work piece moves, edge 128 remains in contact with a bottom surface of the work piece. As mentioned above, the buoyant or spring-loaded embodiments exert a force that is not sufficient to move or lift the corresponding work piece.

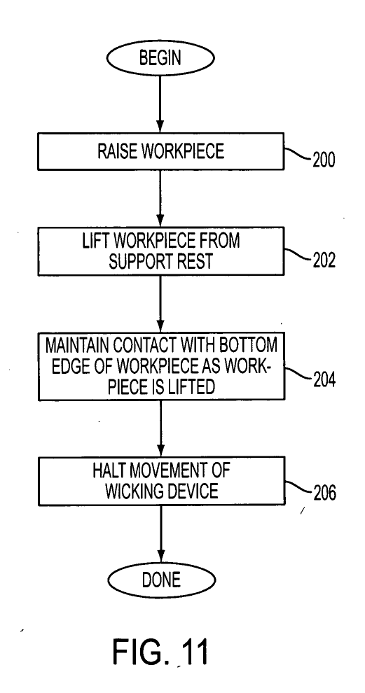

FIG. 11 is a flowchart illustrating the method operations for cleaning a work piece in accordance with one embodiment of the invention. The flowchart initiates with operation 200 by raising a work piece that is submerged in a cleaning bath upon completion of a processing operation. The work piece is raised towards a fluid air interface by a support nest holding the workpiece in one embodiment. The method advances to operation 202 where the work piece is lifted from a submerged support by a transition arm that is disposed above the fluid air interface. The work piece may be lifted as the submerged support is rising or stationary. In operation 204 a bottom edge of the work piece is followed by a wicking device that maintains contact with the bottom edge of the work piece as the work piece is removed from the support. Here, the workpiece is supported by the transition arm, yet the wicking device maintains contact with the bottom edge of the work piece. In operation 206, movement of the wicking device is halted after a top surface of the wicking device breaks the fluid air interface. It should be appreciated that the support remains submerged even while the top surface of the wicking device is above the fluid air interface. The transition arm will remove the work piece to another support nest for further processing in one embodiment.

The above embodiments provide for a wicking device that contacts each work piece to prevent any cleaning/rinsing fluid stains or marks left on the workpiece after a processing or cleaning operations. The wicking device or drip remover essentially provides for a continuum of the water or other cleaning fluid (and associated surface tension and molecular attraction) from the work piece, across the drip remover, to the fluid bath. The continuous contact between the drip remover and the work piece provides a path for the water or cleaning fluid to be pulled off of the work piece by the fluid bath. In one embodiment, a droplet of the cleaning fluid is never allowed to form on the bottom of the work piece as the cleaning fluid is pulled away due to the surface tension and molecular attraction as the work piece and drip remover leave the fluid bath. It should be appreciated that the wicking device may be a disposable part, which may be replaced after any number of processing or cleaning operations are performed. Thus, the wicking device may be considered a consumable in one embodiment.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An apparatus for supporting a work piece, comprising:
a buoyantly moveable device disposed so that as the work piece is lifted from the apparatus supporting the work piece, the buoyantly moveable device follows the work piece.

2. The apparatus of claim 1, wherein buoyancy of the movable device is insufficient to lift the work piece.

3. The apparatus of claim 1, comprising:
outer support rails having support slots for supporting the work piece; and
inner support rails having support slots for supporting the work piece.

4. The apparatus of claim 3, wherein the support slots of the outer and inner support rails are in a saw tooth configuration.

5. The apparatus of claim 1, wherein the moveable device has a hollow center.

6. The apparatus of claim 3, wherein the inner surface of each inner support rail includes a stop to limit vertical movement of the moveable device.

7. The apparatus of claim 1, wherein a top portion of the moveable device extends past a top surface of the apparatus when the moveable device is at a highest vertical height.

8. The apparatus of claim 4, wherein the vertically disposed extensions function as the stop.

9. The apparatus of claim 1, wherein the work piece is circular.

10. A support nest for cleaning a work piece, comprising:
a plurality of spaced apart wicking devices moveably disposed between pairs of vertically disposed extensions extending from inner surfaces of inner support rails, the inner support rails disposed along a length of the support nest, the wicking devices moveable along vertical guides defined along the inner surfaces so that as the work piece is lifted from a cleaning bath, the wicking devices travel with corresponding work pieces, such that when the support nest is submerged in the cleaning bath, a top portion of the wicking devices extends above a surface of the cleaning bath when the wicking device is fully extended.

11. The support nest of claim 10, wherein the wicking device is buoyantly moveable along the vertical guides and a force provided by the wicking device is insufficient to move the work piece.

12. The support nest of claim 10, wherein the wicking device is spring mounted and a force of the spring is insufficient to lift the work piece.

13. The support nest of claim 10, wherein the wicking device has a hollow center region.

14. The support nest of claim 10, wherein the support nest is configurable to hold work pieces having varying diameters.

15. The apparatus of claim 10, wherein the top portion of the wicking device is angled.

16. The apparatus of claim 10, further comprising:
a plurality of pairs of outer support rails placed outside of the inner support rails, the pairs of outer support rails providing support for the work piece.

17. The apparatus of claim 16, wherein the pairs of outer support rails support the work piece in a vertical orientation and wherein the work piece is supported below a midline of the work piece.

18. A method for cleaning a work piece, comprising:
raising a work piece submerged in a cleaning bath toward a bath fluid/air interface;
lifting the work piece from a support with a transition arm located above the fluid/air interface;
following a bottom edge of the work piece with a wicking device moveably attached to the support, the wicking device contacting the bottom edge; and
halting movement of the wicking device after a top portion breaks the bath fluid/air interface.

19. The method of claim 18, wherein the wicking device is one of buoyant or spring force.

20. The method of claim 18, wherein a force exerted by the wicking device is insufficient to lift the work piece.

21. The method of claim 18, wherein a plurality of work pieces are submerged and each work piece is associated with an independently moveable wicking device.

22. The method of claim 18, wherein the support remains submerged during the lifting the following and the halting.
